(19) United States
(12) Patent Application Publication
(10) Pub. No.: US 2007/0257782 A1
(43) Pub. Date: Nov. 8, 2007

(54) System and Method for Multi-Event Capture

(75) Inventor: Jamie Etcheson, El Cajon, CA (US)

Correspondence Address: PROCOPIO, CORY, HARGREAVES & SAVITCH LLP, 530 B STREET, SUITE 2100, SAN DIEGO, CA, 92101, US

(73) Assignee: DRIVECAM, INC., San Diego, CA (US)

(21) Appl. No.: 11/566,539

(22) Filed: Dec. 4, 2006

Related U.S. Application Data
(63) Continuation-in-part of application No. 11/382,222, filed on May 8, 2006.
Application No. 11/382,222 is a continuation-in-part of application No. 11/382,239, filed on May 8, 2006.
Application No. 11/382,239 is a continuation-in-part of application No. 11/382,325, filed on May 9, 2006.
Application No. 11/382,325 is a continuation-in-part of application No. 11/382,328, filed on May 9, 2006.

(51) Int. Cl. B60Q 1/00; G08B 19/00; G08B 1/00

(52) U.S. Cl. 340/425.5; 340/521; 340/531

(57) ABSTRACT

A multi-event capture system and method identifies driving events and coordinates event capture devices to capture and collect driving event data. At least one sensor is configured to detect a driving event. Event capture devices continuously capture driving event data. An event detector monitors the sensor output and has centralized authority to declare a driving event and coordinate subordinate event capture devices to send captured event data for the driving event to the event detector in response to a trigger signal. The event detector compiles the received data into a single event and sends the event to an evaluation server.

### RELATED APPLICATION

The present application is a continuation-in-part of co-pending U.S. patent application Ser. Nos. 11/382,222 and 11/382,239, filed May 8, 2006; and Ser. No. 11/382,325 and 11/382,328, filed May 9, 2006, of concurrent ownership, all of which are incorporated herein by reference in their entirety.

### BACKGROUND

1. Field of the Invention

The present invention generally relates to computer assisted capture of driving events and more specifically relates to capture of a variety of driving events by multiple event capture devices triggered by a single sensor.

2. Related Art

Conventional systems for capturing driving event data usually comprise a plurality of event capture devices, where each of the event capture devices is equipped with its own individual sensor and captures data each time its own sensor is triggered. In such systems, the capture of data by the devices is unsynchronized and each device captures data independently from data collection performed by other capture devices. In result, such systems typically collect a significant amount of data, some of that data are redundant and the captured data are difficult to analyze and consolidate.

Today, there is no conventional system in place that allows one single device, coupled with a vehicle, to have an authority to manage and synchronize other devices in capturing and collecting driving event data. Presently, no conventional system allows one single device to declare which driving event data should be captured and which devices should do the capturing. Furthermore, today, there is no system in place wherein the managing single device communicates with other event capture devices via an in-vehicle wired or wireless network.

Accordingly, what is needed is an efficient system and method for event capture and review that addresses the significant problems in the conventional systems described above.

### SUMMARY

Accordingly, a multi-event capture system and method are provided for identifying driving events and coordinating event capture devices to capture and collect driving event data.

According to one aspect of the invention, a system for multi-event capture comprises at least one sensor coupled with a vehicle, an event detector coupled with the sensor, and a plurality of event capture devices configured to capture driving event data. The function of the sensor is to detect driving events. The event detector monitors the output of the sensor for a threshold value, and after the event detector detects the threshold value, it sends a trigger signal to the event capture devices. When an event capture device receives the trigger signal from the event detector, it sends driving event data to the event detector. The event data may include audio, video, and other information related to the driving event. Examples of event capture devices can include audio devices, still cameras, video cameras, metadata devices, etc.

In one aspect, the event detector communicates with event capture devices over direct and/or indirect wire links established between the event detector and the event capture devices. Direct wire links may include a universal serial bus (USB) cable, a firewire cable, an RS-232 cable, or the like. Indirect wired links may include a packet switched or circuit switched network connection, an Ethernet network connection, a dial up modem connection, etc.

Alternatively, the event detector can communicate with event capture devices over wireless links. Wireless links may include an infrared link, a Bluetooth link, an Institute of Electrical and Electronics Engineers, Inc. (IEEE) 802.11 point-to-point link, an IEEE 802.16 or WiMAX link, a cellular link, or the like.

In one embodiment, the event detector is further configured to store the driving event data and transmit the data periodically to an evaluation server. The evaluation server can aggregate the event data and store the data in a database for future review.

According to another aspect of the present invention, a method for multi-event capture comprises continuously buffering driving event data in event capture devices, monitoring an output of a sensor coupled with an event detector for a threshold value, and identifying the threshold value in the output of the sensor. The method further comprises sending a trigger signal from the event detector to at least two event capture devices on identification of the threshold value output from the sensor, and sending driving event data from those devices to the event detector in response to receipt of the trigger signal.

In one aspect, sending the signals and data between the event detector and the event capture devices involves communicating over a direct wire. Alternatively, sending the data between the event detector and the event capture devices can involve communication over a wireless link or a network.

In one aspect, the method further comprises capturing driving event data directly at the event detector in response to detection of the threshold value and combining the driving event data received from the multiple event capture devices into a single event. The method further comprises storing the event data in a data storage area and sending stored driving event data to an evaluation server.

In one aspect, capturing driving event data comprises capturing video data, audio data and/or metadata. Video data can be captured by a variety of devices, including, but not limited to, still cameras, video cameras or other types of cameras communicatively coupled with the event detector.

In one aspect, captured data pertain to automobile accidents and include information about circumstances surrounding the accidents. For example, accident specific data may include, but are not limited to, location information of the vehicle at the time of the accident, G-forces data acting on the vehicle, speed and direction of the vehicle data, audio/video data from the vehicle during the automobile accident, the status of the vehicle systems such as lights, brakes, engine, etc. That data can be forensically analyzed at the evaluation server in order to determine the cause of the accident. The data can also be compared to data from other automobile accidents.

Other features and advantages will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram illustrating an example event detector in control of a plurality of event capture devices deployed in a vehicle according to an embodiment of the present invention;

FIG. 2 is a block diagram illustrating an example event according to an embodiment of the present invention;

FIG. 3 is a block diagram illustrating an example event traveling from an event detector to an evaluation server according to an embodiment of the present invention;

FIG. 4 is a block diagram illustrating an example event capture device used in connection with various embodiments described herein;

FIG. 5 is a block diagram illustrating an example event detector according to an embodiment of the present invention;

FIG. 6A is a block diagram illustrating an example event detector sending trigger signals to event capture devices according to an embodiment of the present invention;

FIG. 6B is a block diagram illustrating event capture devices sending driving event data to an event detector in response to trigger signals received from the event detector according to an embodiment of the present invention;

FIG. 7A is a flow diagram illustrating an example process for sending a trigger signal from an event detector to event capture devices according to an embodiment of the present invention;

FIG. 7B is a flow diagram illustrating an example process for sending driver event data from an event capture device to an event detector in response to a trigger signal received from the event detector according to an embodiment of the present invention;

FIG. 8 is a block diagram illustrating an exemplary wireless communication device that may be used in connection with the various embodiments described herein; and

FIG. 9 is a block diagram illustrating an exemplary computer system as may be used in connection with various embodiments described herein.

### DETAILED DESCRIPTION

Certain embodiments as disclosed herein provide for a multi-event capture system and method for identifying driving events and coordinating event capture devices to capture and collect driving event data. For example, one system as disclosed herein comprises an event detector coupled with the sensor and configured to monitor the output of the sensor for a threshold value. When the event detector detects the threshold value, it sends a trigger signal to at least two event capture devices. Event capture devices continuously capture data. If any of the capture devices receives the trigger signal, it can send captured driving event data to the event detector. The event data, which can include audio, video, and other information, collectively comprise an event. The event detector can send events to an evaluation server where the data are stored in a database of events. Later on, the driving events can be analyzed (individually or collectively with other data) to provide counseling to fleet drivers, reconstruction and forensic analysis of automobile accidents, scoring of driving skills, ratings of vehicles, and the like.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

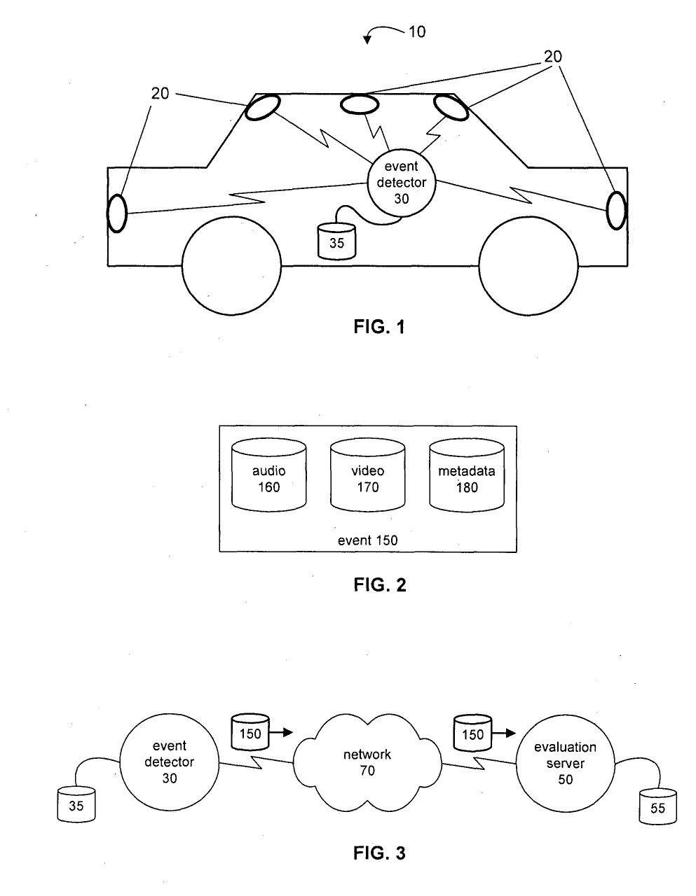

FIG. 1 is a block diagram illustrating an example event detector 30 in control of a plurality of event capture devices 20 deployed in a vehicle 10 according to an embodiment of the present invention. In the illustrated embodiment, the event detector 30 is integrated with the vehicle 10 and is communicatively coupled with the event capture devices 20. The event detector 30 is also configured with data storage 35.

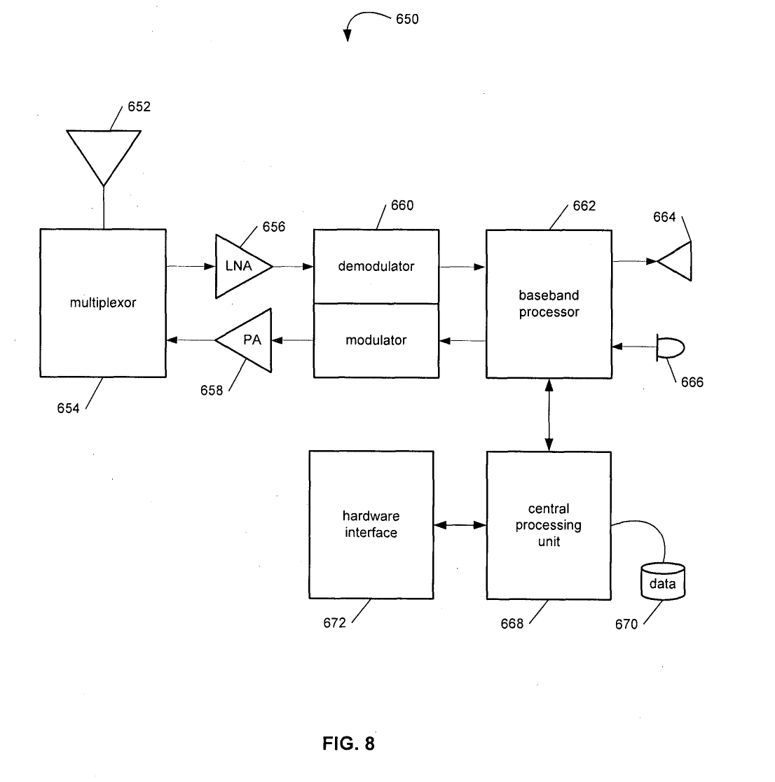

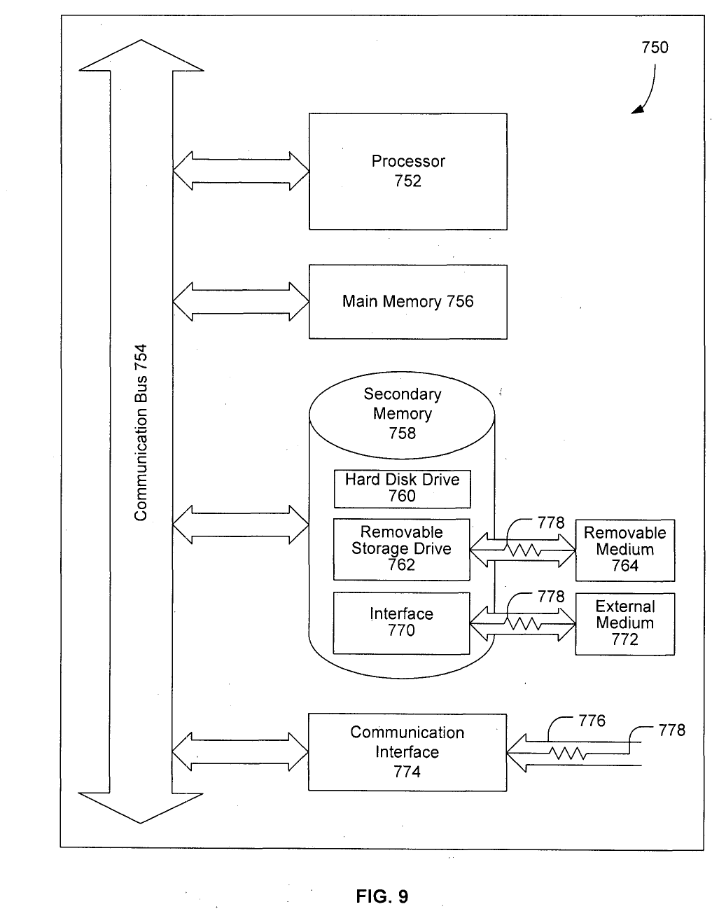

The event detector 30 can be any of a variety of types of computing devices with the ability to execute programmed instructions, receive input from various sensors, and communicate with one or more internal or external event capture devices 20 and other external devices (not shown). An example general purpose computing device that may be employed as all or a portion of an event detector 30 is later described with respect to FIG. 9. An example general purpose wireless communication device that may be employed as all or a portion of an event detector 30 is later described with respect to FIG. 8.

In one embodiment, the event detector 30 monitors a selected sensor and when it detects a driving event, the event detector 30 instructs event capture devices 20 to send data related to the event to the event detector. Then, the event detector can store that data in the data storage area 35 as an event. Events may comprise a variety of situations, including automobile accidents, reckless driving, rough driving, or any other type of stationary or moving occurrence that the owner of a vehicle 10 may desire to know about.

The vehicle 10 can communicate with a plurality of event capture devices placed in various locations within the vehicle 10. In order to provide a comprehensive set of information about driving events, a variety of sensors and devices may be incorporated into event capture devices 20. Examples of event capture devices 20 can include microphones, video cameras, still cameras, and other types of data capture devices. Event capture devices 20 may also comprise an accelerometer that senses changes in speed or direction of the vehicle 10.

Functions of the data storage area 35 can include maintaining data for long term storage and providing efficient and fast access to data, instructions or modules that can be executed by the event detector 30. Examples of the data storage area 35 include any type of internal and external, fixed and removable memory device and may include both persistent and volatile memories.

In one embodiment, the event detector 30 communicatively coupled with at least two event capture devices 20 identifies an event and stores audio and video data along with other information related to the event. For example, related information may include the speed of the vehicle when the event occurred, the direction the vehicle was traveling, the location of the vehicle, etc. The location of the vehicle can be obtained from a global positioning system (“GPS”) sensor. Other information can be obtained from sensors located in and around the vehicle or from the vehicle itself (e.g., from a data bus integral to the vehicle such as an onboard diagnostic (“OBD”) vehicle bus). The collection of audio, video and other data can be compiled into an event and stored in data storage 35 onboard the vehicle for later delivery to an evaluation server.

FIG. 2 is a block diagram illustrating an example event 150 according to an embodiment of the present invention. In the illustrated embodiment, the event 150 comprises audio data 160, video data 170, and metadata 180. Audio data 160 can be collected from inside the vehicle, outside the vehicle, and may include information from an internal vehicle bus about the baseline noise level of the operating vehicle, if such information is available. Additional information about baseline noise level, radio noise level, conversation noise level, or external noise level may also be included in audio data 160.

Video data 170 may include still images or moving video captured by cameras strategically positioned in various locations in and around the vehicle. Video data 170 may include images or video from inside the vehicle, outside the vehicle, or both. In one particularly advantageous embodiment, video data 170, captured by a plurality of image capture devices, include still images and moving video that illustrate the entire area inside the vehicle and the entire 360 degree area surrounding the vehicle.

Metadata 180 may include a variety of additional information that is available to the event detector 30 at the time of an event. Such additional data may include, but is not limited to, the velocity and direction of the vehicle, the GPS location of the vehicle, elevation, time, temperature, vehicle engine and electrical component information, the status of vehicle lights and signals, brake operation and position, throttle position, etc. captured from an internal vehicle bus, just to name a few.

Metadata 180 may also include additional information such as the number of occupants in the vehicle, whether seatbelts were fastened, whether airbags deployed, whether evasive maneuvering was attempted as determined by the route of the vehicle prior to the event, etc. The specific identification of the driver may also be included. For example, metadata 180 may comprise information included in a badge worn by the driver or information included in a key integrated with a vehicle and assigned to the driver (that information can be read by the event detector from radio frequency identification (“RFID”)). As will be understood by those skilled in the art, metadata 180 may include a rich variety of information and the scope of metadata 180 is limited only by the type of information obtained prior to, during, and after an event.

FIG. 3 is a block diagram illustrating an example event 150 traveling from an event detector 30 to an evaluation server 50 according to an embodiment of the present invention. In the illustrated embodiment, events 150 are captured by the event detector 30 and stored locally until they are provided to the evaluation server 50.

The means by which an event 150 can be provided to the evaluation server 50 can vary. In various embodiments (or in a single embodiment), an event 150 may be provided from the event detector 30 to the evaluation server 50 by way of a portable media device, a direct wire link, a direct wireless link, an indirect wire link, an indirect wireless link, or any combination of these. The event 150 may be secured by encryption of the event 150 data structure and/or a secure channel between the event detector 30 and the evaluation server 50. For example, a portable media device used to provide the event 150 to the evaluation server 50 may include a USB drive, compact disc, thumb drive, media card, or other similar type of device (all not shown). A direct wire link may include a USB cable, a firewire cable, an RS-232 cable, or the like. A direct wireless link may include an infrared link, a Bluetooth link, an IEEE 802.11 point-to-point link, a WiMAX link, or a cellular link, just to name a few. An indirect wired link may include a packet switched or circuit switched network connection configured for conveyance of data traffic. An Ethernet network connection is an example of a packet switched indirect wired link and a dial up modem connection is an example of a circuit switched indirect wired link, both of which may be configured for conveyance of data traffic.

In the illustrated embodiment of FIG. 3, the event 150 travels over a network 70 from the event detector 30 to the evaluation server 50. The network 70 may comprise any of a variety of network types and topologies and any combination of such types and topologies. For example, the network 70 may comprise a plurality of networks including private, public, wired, wireless, circuit switched, packet switched, personal area networks (“PAN”), local area networks (“LAN”), wide area networks (“WAN”), metropolitan area networks (“MAN”), or any combination of the these. Network 70 may also include that particular combination of networks ubiquitously known as the Internet.

In one embodiment, network 70 may be a wireless network. In such an embodiment, the network 70 may be accessed by way of one or more access points (not shown) that provide access to the network 70 via many different wireless networking protocols as will be well understood by those having skill in the art. The wireless network 70 may be a WWAN, a WiFi network, a WiMAX network, a cellular network, or other type of wireless network that employs any variety of wireless network technology.

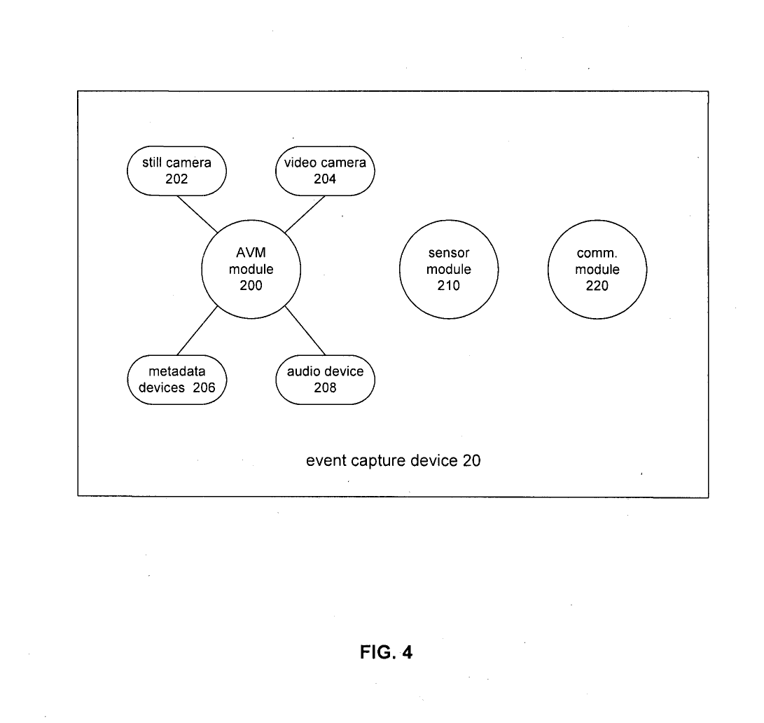

FIG. 4 is a block diagram illustrating an event capture device 20 according to an embodiment of the present invention. In the illustrated embodiment, the event capture device 20 comprises an audio/video/metadata (“AVM”) module 200, a sensor module 210 and a communication module 220. These modules allow the event capture device 20 to continuously capture data, monitor for a trigger signal and, when it receives the trigger signal, to send captured driving event data to the event detector.

In one embodiment, the AVM module 200 is configured to capture and store audio, video and metadata related to driving events. Audio data can be captured by one or more audio devices 208. Examples of audio devices 208 include a microphone, a speaker, etc. Video data can be captured by still cameras 202, video cameras 204, etc. Metadata can be captured by a variety of metadata devices 206 capable of recording data from an accelerometer, a speedometer, GPS sensors, thermometers, an onboard diagnostic vehicle bus, etc. Audio, video and metadata devices can be communicatively coupled with the AVM module 200 of the event capture device 20.

In one embodiment, the sensor module 210 can be configured to manage a variety of sensors which are integral to the event capture device 20. The sensor module 210 may be communicatively coupled with an accelerometer, GPS sensors, temperature sensors, moisture sensors, or the like.

In one embodiment, the communication module 220 can be configured to manage communication between the event capture device 20 and other devices and modules involved in capturing and storing driving event data. For example, the communication module 220 may handle communication between the event capture device 20 and an event detector. The communication module 220 may also handle communication between the event capture device 20 and a memory device, a docking station, or a data server such as an evaluation server. The communication module 220 can be configured to communicate with these various types of devices and other types of devices via a direct wire link (e.g., USB cable, firewire cable), a direct wireless link (e.g., infrared, Bluetooth), wired or wireless network link such as a local area network (“LAN”), a wide area network (“WAN”), a wireless wide area network (“WWAN”), an IEEE 802 wireless network such as an IEEE 802.16 (“WiFi”) network, a WiMAX network, a cellular network, etc.

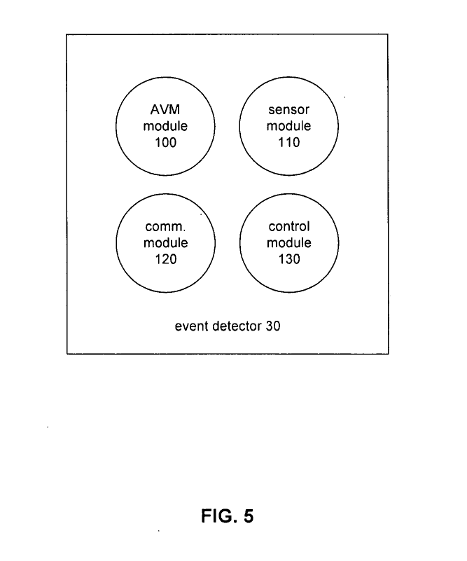

FIG. 5 is a block diagram illustrating an example event detector 30 according to an embodiment of the present invention. In the illustrated embodiment, the event detector 30 comprises an audio/video/metadata (“AVM”) module 100, a sensor module 110, a communication module 120, and a control module 130. Additional modules may also be employed to carry out the various functions of the event detector 30, as will be understood by those having skill in the art. The event detector 30 may also function as an event capture device in one embodiment of the invention.

In one embodiment, the AVM module 100 is configured to manage the capturing and collecting of audio, video and metadata provided by event capture devices. The AVM module 100 can receive data from event capture devices, store the data in data storage, and make the data available to other modules or devices.

In one embodiment, the sensor module 110 is configured to manage sensors communicatively coupled with the vehicle. For example, the sensor module 110 can monitor an output of a sensor coupled with the event detector 30 for a threshold value, identify the threshold value in the output of the sensor, and send a trigger signal to the control module 130 to initiate the receiving of event data from event capture devices.

The sensor module 110 can manage different types of sensors. Types of sensors can include sensors that are coupled with accelerometers, GPS sensors, temperature sensors, moisture sensors, or the like (all not shown). These sensors can be integral to the event detector 30 or external from the event detector 30. For example, an accelerometer may be integral to the event detector 30 or it may be located elsewhere in the vehicle.

In one embodiment, the communication module 120 is configured to manage communication between the event detector 30 and other devices and/or modules. For example, the communication module 120 may handle communication between the event detector 30 and the various event capture devices. The communication module 120 may also handle communication between the event detector 30 and a memory device, a docking station, or a data server such as an evaluation server.

Similarly to the communication module of the event capture device, the communication module 120 of the event detector 30 can be configured to communicate with the various types of devices via a direct wire link (e.g., USB cable, firewire cable), a direct wireless link (e.g., infrared, Bluetooth), or a wired or wireless network link such as a local area network (“LAN”), a wide area network (“WAN”), a wireless wide area network (“WWAN”), an IEEE 802 wireless network such as an IEEE 802.16 (“WiFi”) network, a WiMAX network, or a cellular network (all not shown).

In one embodiment, the control module 130 is configured to control actions of other modules and remote devices such as event capture devices, etc. For example, after receiving a signal from the sensor module 110 indicating that the sensor module 110 has detected a sensor output equal to or greater than a threshold value, the control module 130 determines which event capture devices should send event data to the event detector 30, sends a trigger signal to the event capture devices, instructs the AVM module 100 to receive data from the selected event capture devices, and instructs the communication module 120 to send the received data to an evaluation server.

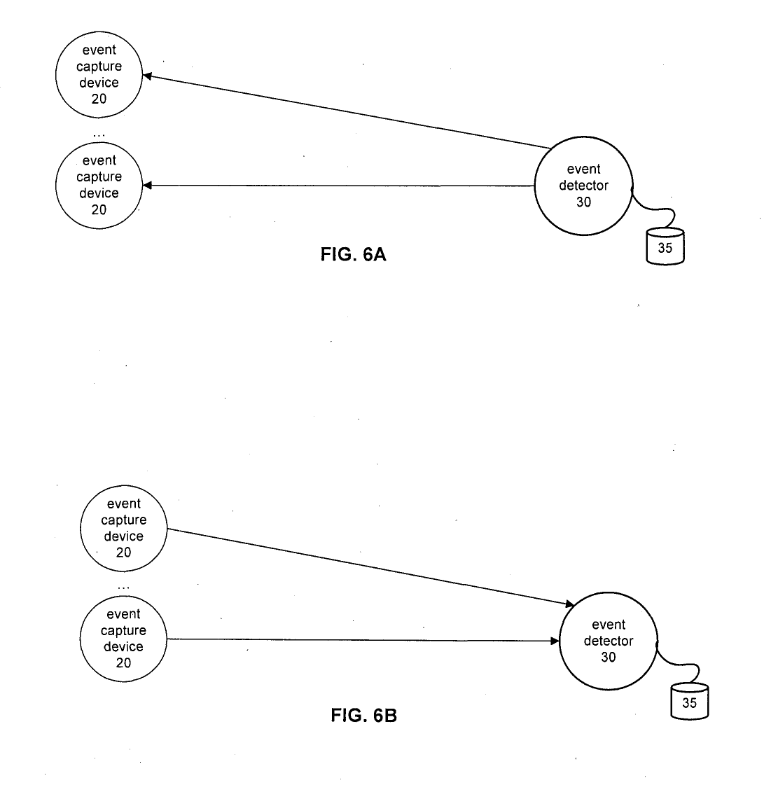

FIG. 6A is a block diagram illustrating an example event detector 30 sending trigger signals to event capture devices 20 according to an embodiment of the present invention. In the illustrated embodiment, the event detector 30 determines when captured event data should be collected from particular event capture devices 20. The event detector 30 can make that determination by monitoring an output of its sensor for a threshold value and once it detects the threshold value, by selecting at least two event capture devices 20 and sending trigger signals to those devices so that data captured by those devices is sent to the event detector 30. In one embodiment, the event detector may send trigger signals to all of the event capture devices on detection of a threshold value from the selected sensor.

The threshold value of the event detector sensor can be set manually (e.g. by an operator) or automatically (e.g. by vehicle systems such as an engine, lights, brakes and other systems that are triggered when a vehicle gets involved in a collision, etc.) Alternatively, the threshold value can be set by a computer communicatively coupled with the event detector 30.

The event detector 30 can select event capture devices based on information externally provided to the event detector 30, information already stored in the data storage 35 of the event detector 30, or based on any other information available to the event detector 30 at the commencement of a valid driving event.

FIG. 6B is a block diagram illustrating event capture devices 20 sending driving event data to an event detector 30 in response to trigger signals received from the event detector 30 according to an embodiment of the present invention. In the illustrated embodiment, each of the event capture devices 20 continuously captures data, stores the data in a buffer until the buffer is full, and then writes over the previously captured data with new data, repeating the process of filling the buffer with new data over and over again. When the event capture device 20 receives a trigger signal from the event detector 20 to send the data, the event capture device 20 sends each data buffer with newly captured data to the event detector 30, rather than simply writing over the data. The event capture devices capture data continuously whether or not they are triggered to forward captured data to the event detector.

In the illustrated embodiment, the event capture device 20 continues repeating the cycle of capturing new data to the buffer and sending the buffer to the event detector 30 during a detected driving event. But, as soon as the event detector 30 instructs the event capture device to stop sending data, the event capture device 20 stops sending data to the event detector 30, and continues the capturing of data to the buffer while waiting for the next trigger signal. In one embodiment, event capture devices are switched into an active mode to continuously send captured data to the event detector on receipt of the trigger signal. The devices may be switched back into an inactive mode in which they continue to capture data but do not forward the data to the event detector once it is determined that the driving event indicated by the sensor is over. There are many possible techniques for instructing the event capture devices to stop sending data to the event detector. One would be by continuing to monitor the triggering sensor output and sending an “OFF” signal to the event capture devices when the sensor output falls back below the threshold. Alternatively, a timer may be used to determine when to stop collecting event data at the event detector, with the event detector sending an “OFF” or end transmission signal to the event capture devices on expiry of a predetermined time period. In another embodiment, a different sensor output may be used to determine when to instruct the event capture devices to stop sending data to the event detector.

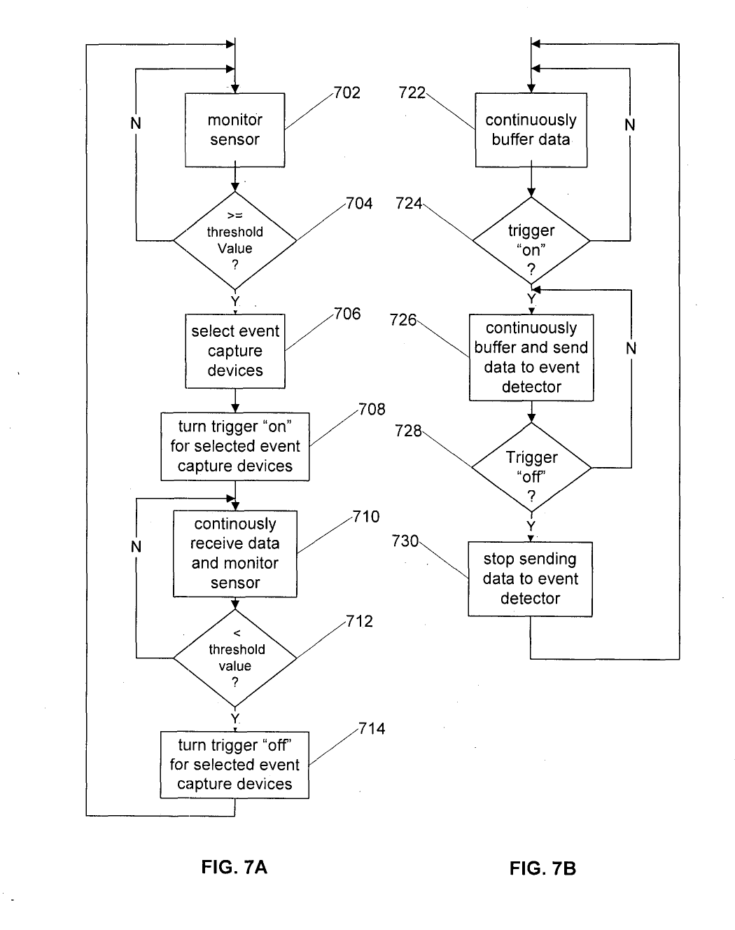

FIG. 7A is a flow diagram illustrating an example process for sending a trigger signal from an event detector to event capture devices according to an embodiment of the present invention. In the illustrated embodiment, the event detector determines when captured event data should be collected, which event capture devices should collect the data and when the selected event capture devices should collect the data.

At a step 702, the event detector monitors an output of its sensor for a threshold value. The threshold value is a minimal value of the sensor signal (measured in the appropriate units) that the signal has to attain before the collecting of driving data can begin. The threshold value for the event detector sensor can be set manually (e.g. by an operator) or automatically (e.g. by vehicle systems such as an engine, lights, brakes and other systems that are triggered when a vehicle gets involved in a collision, etc.) Alternatively, the threshold value can be set by a computer communicatively coupled with the event detector 30. The sensor signal can be continuously updated by a sensing device coupled with the event detector.

At a step 704, the event detector compares the value of its sensor output to the threshold value. If the value of the sensor output is equal to, or greater than the threshold value, the event detector can interpret that information as a commencement of a valid driving event and request the sending of event data from event capture devices. Otherwise (if the value of the sensor output remains below the threshold value), the event detector can interpret that information as lack of a valid driving event and thus it can continue monitoring its sensor and waiting for a valid driving event.

At a step 706, the event detector selects at least two event capture devices to provide the event data to the event detector. The event detector can make that selection based on information externally provided to the event detector, information already stored in the data storage of the event detector, or based on any other information available to the event detector at the commencement of a valid driving event.

At a step 708, the event detector sends a trigger signal to the selected event capture devices. The trigger signal indicates that each of the selected event capture devices should start sending the captured event data to the event detector and should continue sending the subsequently captured event data until instructed otherwise, or as long as the trigger signal remains “on.” The event detector receives the event data from the selected event capture devices and passes that data to an evaluation server.

At a step 710, the event detector continues receiving data from the event capture devices and continues monitoring an output of its sensor for a threshold value. As described above, the threshold value is a minimal value of the sensor signal (measured in the appropriate units) that has to be maintained for the event detector to continue requesting the sending of data. The threshold value for the event detector sensor can be set manually (e.g. by an operator) or automatically (e.g. by vehicle systems such as an engine, lights, brakes and other systems that are triggered when a vehicle gets involved in a collision, etc.) Alternatively, the threshold value can be set by a computer communicatively coupled with the event detector.

At a step 712, the event detector compares the value of its sensor output to the threshold value. If the value of the sensor output falls below the threshold value, the event detector can interpret that information as an end of the valid driving event and instruct the event capture devices to stop sending the event data. Otherwise (if the value of the sensor output remains at or above the threshold value), the event detector continues to collect data from the event capture devices.

At a step 714, the event detector turns a trigger signal to “off” and sends the trigger off signal to the selected event capture devices that were sending data to the event detector. The trigger signal set to “off” indicates that the event capture devices should stop sending the captured event data to the event detector. Once the event detector stops receiving and collecting driving event data, it returns to monitoring of its sensor for an output greater than or equal to the threshold value. After the event detector has received all captured data from the selected event capture devices for one driving event, the data can be combined into a single driving event and sent to the evaluation server.

In the method illustrated in FIG. 7A, event capture devices are instructed to stop sending captured driving event data to the event detector when the output of the sensor falls below the threshold value. However, it will be understood that other events may be used as a trigger to end the sending of data from the event capture devices, such as an output from a different sensor, or a timer output.

FIG. 7B is a flow diagram illustrating an example process for sending driving event data from an event capture device to an event detector in response to the trigger signal received from the event detector according to an embodiment of the present invention. In the illustrated embodiment, the event capture device continuously buffers incoming data and sends the data to the event detector only when the event detector requests them.

At a step 722, the event capture device continuously captures data, stores them in a buffer until the buffer is full, and then writes over the previously captured data with new data. The event capture device repeats the process of filling the buffer with new data over and over again until it receives a trigger signal from an event detector. At that point, the event capture devices sends each of the buffers with newly captured data to the event detector.

At a step 724, the event capture device monitors a trigger input for receipt of a trigger signal. The trigger input is a wired or wireless link between the event capture device and the event detector, and provides the event capture device with information on whether the captured data should be sent to the event detector. If the trigger is “on,” the event capture device can interpret that information as a request to start sending captured event data to the event detector because a valid driving event has commenced. Otherwise (if the trigger is “off”), the event capture device can interpret that information as lack of a valid driving event and thus the event capture device should not send any of the captured data to the event detector.

At a step 726, the event capture device determines that the trigger is set to “on” and starts sending the captured event data to the event detector. The event capture device continues capturing incoming data and sending the captured event data as long as the trigger signal remains set to “on.”

At a step 728, the event capture device continues monitoring the status of its trigger. As described above, as long as the trigger is “on,” the event capture device can interpret that information as a continuous request to send the captured event data to the event detector because the valid driving event is still in progress. But, when the trigger is turned “off,” the event capture device will stop sending any of the captured data to the event detector.

At a step 730, the event capture device detects that the trigger signal is “off” and stops the sending of captured data to the event detector. The trigger signal set to “off” indicates that the valid driving event ended and thus the event capture device should stop sending the captured data to the event detector. Once the event capture device stops the sending of captured data, it continues capturing and buffering of incoming data and waits for a new request to send data to the event detector.

FIG. 8 is a block diagram illustrating an exemplary wireless communication device 650 that may be used in connection with the various embodiments described herein. For example, the wireless communication device 650 may be used in conjunction with an event detector previously described with respect to FIG. 1 and FIG. 5, or an event capture device previously described with respect to FIG. 4. However, other wireless communication devices and/or architectures may also be used, as will be clear to those skilled in the art.

In the illustrated embodiment, the wireless communication device 650 comprises an antenna 652, a multiplexor 654, a low noise amplifier (“LNA”) 656, a power amplifier (“PA”) 658, a modulation circuit 660, a baseband processor 662, a speaker 664, a microphone 666, a central processing unit (“CPU”) 668, a data storage area 670, and a hardware interface 672. In the wireless communication device 650, radio frequency (“RF”) signals are transmitted and received by antenna 652. Multiplexor 654 acts as a switch, coupling antenna 652 between the transmit and receive signal paths. In the receive path, received RF signals are coupled from a multiplexor 654 to LNA 656. LNA 656 amplifies the received RF signal and couples the amplified signal to a demodulation portion of the modulation circuit 660.

Typically modulation circuit 660 will combine a demodulator and modulator in one integrated circuit (“IC”). The demodulator and modulator can also be separate components. The demodulator strips away the RF carrier signal leaving a base-band receive audio signal, which is sent from the demodulator output to the base-band processor 662.

If the base-band receive audio signal contains audio information, then base-band processor 662 decodes the signal and converts it to an analog signal. Then the signal is amplified and sent to the speaker 664. The base-band processor 662 also receives analog audio signals from the microphone 666. These analog audio signals are converted to digital signals and encoded by the base-band processor 662. The base-band processor 662 also codes the digital signals for transmission and generates a base-band transmit audio signal that is routed to the modulator portion of modulation circuit 660. The modulator mixes the base-band transmit audio signal with an RF carrier signal generating an RF transmit signal that is routed to the power amplifier 658. The power amplifier 658 amplifies the RF transmit signal and routes it to the multiplexor 654 where the signal is switched to the antenna port for transmission by antenna 652.

The baseband processor 662 is also communicatively coupled with the central processing unit 668. The central processing unit 668 has access to a data storage area 670. The central processing unit 668 is preferably configured to execute instructions (i.e., computer programs or software) that can be stored in the data storage area 670. Computer programs can also be received from the baseband processor 662 and stored in the data storage area 670 or executed upon receipt. Such computer programs, when executed, enable the wireless communication device 650 to perform the various functions of the present invention as previously described.

In this description, the term “computer readable medium” is used to refer to any media used to provide executable instructions (e.g., software and computer programs) to the wireless communication device 650 for execution by the central processing unit 668. Examples of these media include the data storage area 670, microphone 666 (via the baseband processor 662), antenna 652 (also via the baseband processor 662), and hardware interface 672. These computer readable mediums are means for providing executable code, programming instructions, and software to the wireless communication device 650. The executable code, programming instructions, and software, when executed by the central processing unit 668, preferably cause the central processing unit 668 to perform the inventive features and functions previously described herein.

The central processing unit is also preferably configured to receive notifications from the hardware interface 672 when new devices are detected by the hardware interface. Hardware interface 672 can be a combination electromechanical detector with controlling software that communicates with the CPU 668 and interacts with new devices.

FIG. 9 is a block diagram illustrating an exemplary computer system 750 that may be used in connection with the various embodiments described herein. For example, the computer system 750 may be used in conjunction with an event detector previously described with respect to FIG. 1, and FIG. 5. However, other computer systems and/or architectures may be used, as will be clear to those skilled in the art.

The computer system 750 preferably includes one or more processors, such as processor 752. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 752.

The processor 752 is preferably connected to a communication bus 754. The communication bus 754 may include a data channel for facilitating information transfer between storage and other peripheral components of the computer system 750. The communication bus 754 further may provide a set of signals used for communication with the processor 752, including a data bus, address bus, and control bus (not shown). The communication bus 754 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, mini PCI express, or standards promulgated by the Institute of Electrical and Electronics Engineers (“IEEE”) including IEEE 488 general-purpose interface bus (“GPIB”), IEEE 696/S-100, and the like.

Computer system 750 preferably includes a main memory 756 and may also include a secondary memory 758. The main memory 756 provides storage of instructions and data for programs executing on the processor 752. The main memory 756 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 758 may optionally include a hard disk drive 760 and/or a removable storage drive 762, for example a floppy disk drive, a magnetic tape drive, a compact disc (“CD”) drive, a digital versatile disc (“DVD”) drive, etc. The removable storage drive 762 reads from and/or writes to a removable storage medium 764 in a well-known manner. Removable storage medium 764 may be, for example, a floppy disk, magnetic tape, CD, DVD, memory stick, USB memory device, etc.

The removable storage medium 764 is preferably a computer readable medium having stored thereon computer executable code (i.e., software) and/or data. The computer software or data stored on the removable storage medium 764 is read into the computer system 750 as electrical communication signals 778.

In alternative embodiments, secondary memory 758 may include other similar means for allowing computer programs or other data or instructions to be loaded into the computer system 750. Such means may include, for example, an external storage medium 772 and an interface 770. Examples of external storage medium 772 may include an external hard disk drive or an external optical drive, or an external magneto-optical drive.

Other examples of secondary memory 758 may include semiconductor-based memory such as programmable read-only memory (“PROM”), erasable programmable read-only memory (“EPROM”), electrically erasable read-only memory (“EEPROM”), or flash memory. Also included are any other removable storage units 772 and interfaces 770, which allow software and data to be transferred from the removable storage unit 772 to the computer system 750.

Computer system 750 may also include a communication interface 774. The communication interface 774 allows software and data to be transferred between computer system 750 and external devices (e.g. printers), networks, or information sources. For example, computer software or executable code may be transferred to computer system 750 from a network server via communication interface 774. Examples of communication interface 774 include a modem, a network interface card (“NIC”), a communications port, a PCMCIA slot and card, an infrared interface, and an IEEE 1394 fire-wire, just to name a few.

Communication interface 774 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 774 are generally in the form of electrical communication signals 778. These signals 778 are preferably provided to communication interface 774 via a communication channel 776. Communication channel 776 carries signals 778 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 756 and/or the secondary memory 758. Computer programs can also be received via communication interface 774 and stored in the main memory 756 and/or the secondary memory 758. Such computer programs, when executed, enable the computer system 750 to perform the various functions of the present invention as previously described.

In this description, the term “computer readable medium” is used to refer to any media used to provide computer executable code (e.g., software and computer programs) to the computer system 750. Examples of these media include main memory 756, secondary memory 758 (including hard disk drive 760, removable storage medium 764, and external storage medium 772), and any peripheral device communicatively coupled with communication interface 774 (including a network information server or other network device). These computer readable mediums are means for providing executable code, programming instructions, and software to the computer system 750.

In an embodiment that is implemented using software, the software may be stored on a computer readable medium and loaded into computer system 750 by way of removable storage drive 762, interface 770, or communication interface 774. In such an embodiment, the software is loaded into the computer system 750 in the form of electrical communication signals 778. The software, when executed by the processor 752, preferably causes the processor 752 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A method for multi-event capture comprising:
continuously buffering driving event data in a plurality of event capture devices;
monitoring an output of a sensor coupled with an event detector for a threshold value;
identifying the threshold value in the output of the sensor;
sending a trigger signal from the event detector to at least two of the plurality of event capture devices; and
sending driving event data from at least two event capture devices to the event detector in response to receipt of the trigger signal.

2. The method of claim 1, wherein sending data between the event detector and event capture devices comprises sending data over a direct wire.

3. The method of claim 1, wherein sending data between the event detector and event capture devices comprises sending data over a wireless link.

4. The method of claim 1, wherein sending data between the event detector and event capture devices comprises sending data over a network.

5. The method of claim 1, further comprising:
storing driving event data from the plurality of event capture devices in a data storage area of the event detector; and
sending stored driving event data to an evaluation server.

6. The method of claim 5, further comprising combining driving event data received from at least two event capture devices into a single event and sending the single event to the evaluation server.

7. The method of claim 1, wherein capturing driving event data comprises capturing video data.

8. The method of claim 1, wherein capturing driving event data further comprises capturing video data from a plurality of event capture devices communicatively coupled with the event detector.

9. The method of claim 1, wherein capturing driving event data further comprises capturing audio data.

10. The method of claim 1, wherein capturing driving event data further comprises capturing metadata.

11. The method of claim 1, wherein sending a trigger signal from the event detector to at least two event capture devices comprises sending the trigger signal in response to detection of the threshold value.

12. A system for multi-event capture comprising:
at least one sensor coupled with a vehicle, the sensor configured to detect a driving event;
a plurality of event capture devices coupled with the vehicle, the event capture devices configured to capture driving event data; and
an event detector coupled with the sensor and configured to monitor the output of the sensor for a threshold value, and to send a trigger signal to the event capture devices when the threshold value is detected, wherein the event capture devices are further configured to receive the trigger signal from the event detector and send driving event data to the event detector in response to the trigger signal.

13. The system of claim 12, further comprising a direct wire link connecting the event detector with the event capture device.

14. The system of claim 12, further comprising a wireless link connecting the event detector with the event capture device.

15. The system of claim 12, further comprising a network connecting the event detector with the event capture device.

16. The system of claim 12, wherein the event detector is further configured to store driving event data and transmit the data to an evaluation server.

17. The system of claim 16, wherein the event detector is configured to combine driving event data received from the event capture devices in response to the trigger signal into a single driving event and to transmit the single driving event to the evaluation server.

18. The system of claim 12, wherein the event capture device is a camera.

19. The system of claim 12, wherein the driving event data comprises video data.

20. The system of claim 12, wherein the driving event data comprises audio data.

21. The system of claim 12, wherein the driving event data comprises metadata.

22. The system of claim 12, further comprising a plurality of sensors coupled with the vehicle, each sensor configured to detect driving events.
